(19) United States
(12) Patent Application Publication
(10) Pub. No.: US 2026/0358555 A1
(43) Pub. Date: Nov. 12, 2026

(54) OPTICAL FIBER WITH PERTURBATION-SENSITIVE SEGMENT

(71) Applicant: nLIGHT, Inc., Camas, WA (US)

(72) Inventors: Juan Lugo, Vancouver, WA (US); Roger Farrow, Vancouver, WA (US); Dahv Kliner, Portland, OR (US)

(21) Appl. No.: 19/670,339

(22) Filed: May 7, 2026

Related U.S. Application Data
(60) Provisional application No. 63/801,997, filed on May 8, 2025.

(51) Int. Cl. G02B 6/028; G02B 6/036

(52) U.S. Cl. CPC G02B 6/0285; G02B 6/03633

(57) ABSTRACT

An optical fiber includes first and second segments of a continuous length and having respective first and second refractive index profiles (RIPs). The first and second RIPs differ from each other. Specifically, the second RIP renders the second segment more sensitive to perturbation of the optical fiber than the first segment. This perturbation sensitivity can be leveraged to more easily switch, for example, light propagating in the core of the optical fiber into a combination of the core and inner cladding region of a double-clad optical fiber or, as another example, light propagating in the central core of a core-and-ring optical fiber at least partially into a ring core of such a fiber. Amongst other consequences, this switching will alter the shape, size, and/or divergence profile of the beam output from the optical fiber when the perturbation is applied to some or all of the second segment.

### CROSS-REFERENCE TO RELATED PATENT APPLICATION(S)

This United States Non-Provisional Application relies for priority on and claims priority to U.S. patent application Ser. No. 63/801,997 , filed on May 8, 2025, the entire contents of which are incorporated herein by reference.

### FIELD

The present disclosure relates generally to optical fibers. In particular, the present disclosure relates to optical fibers that include segments having heightened sensitivity to perturbations of the optical fiber, such as bending.

### BACKGROUND

High-power fiber-coupled lasers are popular for a variety of applications, such as materials processing, cutting, welding, and additive manufacturing. These lasers include, for example, fiber lasers, disk lasers, diode lasers, and diode-pumped solid-state lasers. In these systems, optical power is delivered from the laser to a workpiece via an optical fiber.

Different fiber-coupled laser materials processing tasks require different beam characteristics (e.g., spatial profiles and/or divergence profiles). For example, cutting thick metal generally requires a larger spot size than cutting thin metal, and deep-penetration welding requires a different beam shape than shallow (conduction) welding. It is therefore often desirable for the laser beam properties to be adjustable to enable optimized processing for different tasks.

Those of ordinary skill in the art will be familiar with certain all-fiber solutions for varying laser beam properties to achieve the above objectives. For instance, Corona® fiber lasers (nLIGHT, Inc.; Camas, WA) employ an optical fiber that incorporates a first length having a first refractive index profile (RIP) and a second length having a second RIP that is different from the first RIP. The RIP of the first length of the fiber is such that characteristics of a laser beam propagating therethrough may be modified by applying perturbations, such as bending, thereto. For example, the first length of fiber may be a graded (e.g., parabolic) index fiber because bending such a fiber causes light to shift radially from the central axis of the first length of fiber in a well-controlled manner. The RIP of the second length of the fiber is such that it at least partially captures and preserves the beam characteristics that are modified in the first length of the fiber to the output end of the second length of the fiber (e.g., to a processing head). For example, the RIP of the second length of the fiber may have two or more regions with relatively higher refractive indices, each of which is separated from the others by region(s) having relatively lower refractive indices, such that light coupled into one higher-index region cannot propagate or significantly couple into another higher-index region. Such optical fibers are described, for example, in U.S. Pat. Nos. 10,295,845; 10,423,015; and 10,663,767, all of which are hereby incorporated by reference as though fully set forth herein.

### BRIEF SUMMARY

The instant disclosure provides an optical fiber having a continuous length, the optical fiber including: a first segment of the continuous length, having a first refractive index profile (RIP); and a second segment of the continuous length, having a second RIP different from the first RIP, wherein the second RIP renders the second segment more sensitive to perturbation of the optical fiber than the first segment.

A length of the second segment may be between about 1 cm and about 100 cm.

The optical fiber may have a transverse cross-sectional dimension that varies along the continuous length, with the transverse cross-sectional dimension of the optical fiber within the first segment being greater than the transverse cross-sectional dimension of the optical fiber within the second segment. For instance, the transverse cross-sectional dimension within the second segment may be between about 20% and about 90% of the transverse cross-sectional dimension within the first segment (e.g., the transverse cross-sectional dimension may be an outer diameter, and a ratio of the outer diameter of the optical fiber within the first segment to the outer diameter of the optical fiber within the second segment may be between about 1.1 and about 5).

The outer diameter of the optical fiber within the first segment may taper (e.g., continuously or in a stepwise fashion) to the outer diameter of the optical fiber within the second segment at a transition between the first segment and the second segment. In turn, it is contemplated that the second RIP may be a proportional reduction of the first RIP.

In other aspects, the optical fiber can include an outer cladding extending along the continuous length, and at least a portion of a thickness of the outer cladding may be removed about a circumference of the second segment.

The optical fiber may also have a transverse cross-sectional shape that varies along the continuous length. For instance, the transverse cross-sectional shape within the first segment may have n-fold symmetry about an axis along the continuous length, while the transverse cross-sectional shape within the second segment does not have n-fold symmetry about the axis along the continuous length (n being an integer greater than one). As another example, the transverse cross-sectional shape within the first segment may be circular, and the transverse cross-sectional shape within the second segment may be non-circular (such as D-shaped).

The optical fiber can include an outer cladding extending along the continuous length. The outer cladding has a refractive index, and the refractive index of the outer cladding may be higher within the second segment than within the first segment.

Optionally, the optical fiber includes a third segment of the continuous length, having a third RIP. The second segment of the continuous length may be interposed between the first segment and the third segment. The third RIP may be identical to the first RIP.

Also disclosed herein is a method of manufacturing an optical fiber having a continuous length. The method includes forming a first segment of the continuous length, the first segment having a first refractive index profile (RIP); and forming a second segment of the continuous length, the second segment having a second RIP different from the first RIP, wherein the second RIP renders the second segment more sensitive to perturbation of the optical fiber than the first segment.

The optical fiber may have a transverse cross-sectional dimension, and the step of forming the second segment of the continuous length may include reducing the transverse cross-sectional dimension of the optical fiber within the second segment. For instance, the transverse cross-sectional dimension of the optical fiber may be reduced within the second segment by stretching the second segment such that the second RIP is a proportional reduction of the first RIP.

As another example, the transverse cross-sectional dimension of the optical fiber may be reduced within the second segment by removing at least a portion of a thickness of an outer cladding of the optical fiber within the second segment, such as by grinding away at least the portion of the thickness of the outer cladding of the optical fiber, etching away at least the portion of the thickness of the outer cladding of the optical fiber, and/or evaporating away at least the portion of the thickness of the outer cladding of the optical fiber. The removal may result in a transverse cross-sectional shape of the second segment that does not have n-fold symmetry (n is an integer greater than one), about an axis along the continuous length.

It is also contemplated that the step of forming the second segment of the continuous length may include heating the second segment of the continuous length.

The instant disclosure also provides an optical fiber having a continuous length formed according to a process including: forming the continuous length, and modifying a segment of the continuous length such that the segment of the continuous length is more sensitive to perturbation than a remainder of the continuous length.

The step of modifying the segment of the continuous length may include heating the segment of the continuous length.

Alternatively or additionally, the step of modifying the segment of the continuous length can include removing at least a portion of an outer cladding of the optical fiber within the segment of the continuous length (e.g., uniformly or non-uniformly removing at least the portion of the outer cladding of the optical fiber about a perimeter of the optical fiber).

In still further aspects, the step of modifying the segment of the continuous length can include proportionally reducing a refractive index profile (RIP) of the optical fiber within the segment of the continuous length (e.g., by stretching the optical fiber to form the segment as a tapered region of the continuous length).

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic illustration of an optical fiber including a perturbation-sensitive segment as disclosed herein.

FIG. 2A illustrates an optical fiber including a perturbation-sensitive segment according to a first aspect of the disclosure.

FIG. 2B is a transverse cross-sectional view taken along line B-B in FIG. 2A, presented side-by-side with its corresponding refractive index profile (RIP).

FIG. 2C is a transverse cross-sectional view taken along line C-C in FIG. 2A, presented side-by-side with its corresponding RIP.

FIG. 3A illustrates an optical fiber including a perturbation-sensitive segment according to a second aspect of the disclosure.

FIG. 3B is a transverse cross-sectional view taken along line B-B in FIG. 3A, presented side-by-side with its corresponding RIP.

FIG. 3C is a transverse cross-sectional view taken along line C-C in FIG. 3A, presented side-by-side with its corresponding RIP.

FIG. 4A illustrates an optical fiber including a perturbation-sensitive segment according to a third aspect of the disclosure.

FIG. 4B is a transverse cross-sectional view taken along line B-B in FIG. 4A, presented side-by-side with its corresponding RIP.

FIG. 4C is a transverse cross-sectional view taken along line C-C in FIG. 4A, presented side-by-side with its corresponding RIP.

FIG. 5A illustrates an optical fiber including a perturbation-sensitive segment according to a fourth aspect of the disclosure.

FIG. 5B is a transverse cross-sectional view taken along line B-B in FIG. 5A, presented side-by-side with its corresponding RIP.

FIG. 5C is a transverse cross-sectional view taken along line C-C in FIG. 5A, presented side-by-side with two corresponding RIP variations.

FIG. 6A is an exemplary RIP for a core-and-ring optical fiber.

FIGS. 6B through 6F are exemplary RIPs for a perturbation-sensitive segment of a core-and-ring optical fiber.

While multiple embodiments are disclosed, still other embodiments of the present disclosure will become apparent to those skilled in the art from the following detailed description, which shows and describes illustrative embodiments. Accordingly, the drawings and detailed description are to be regarded as illustrative in nature and not restrictive.

### DETAILED DESCRIPTION

The instant disclosure provides optical fibers including perturbation-sensitive segments. As used herein, the term “segment” refers to a portion of an overall length of an optical fiber. On the other hand, the term “region” is used herein to describe portions of an optical fiber that together make up the transverse cross-sectional configuration of the fiber. For instance, in a double-clad optical fiber, the core and each of the claddings is a “region.” Likewise, in an optical fiber where the core is positioned off the central axis of the fiber, each of the non-coaxial core and the cladding is a “region.”

In connection with the teachings herein, the question of whether a segment of an optical fiber is “perturbation-sensitive” can be assessed by reference to the loss coefficient of a region, or to the coupling coefficient between regions, for that segment relative to other segments of the optical fiber (e.g., the remaining overall length of the optical fiber). Thus, within a perturbation-sensitive segment of a given optical fiber, a given loss (e.g., bend loss from the core of the optical fiber into a larger region of the optical fiber) or coupling of optical power among regions of the optical fiber can be achieved over a considerably shorter length or with a substantially lower magnitude perturbation (e.g., larger bend radius) relative to a segment of the optical fiber that is not perturbation-sensitive.

It should be appreciated, however, that perturbation sensitivity is relative rather than absolute. That is, whether a segment of an optical fiber is perturbation-sensitive within the meaning of the present disclosure is assessed with reference to the fiber as a whole, and not to the segment considered alone. For purposes of the present disclosure, a segment of an optical fiber is perturbation-sensitive if its loss coefficient and/or coupling coefficient differs from the loss and/or coupling coefficients of adjacent segments of the optical fiber by a factor of at least two.

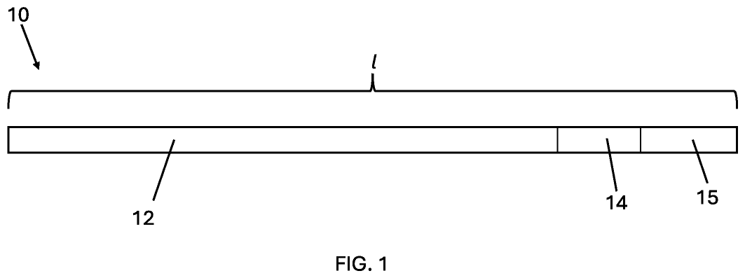

FIG. 1 is a schematic depiction of an exemplary optical fiber 10 having a continuous length/made up of two or more segments. As used in this disclosure, the term “continuous length” excludes splices and other methods of joining separate and distinct segments of fiber together.

For purposes of illustration, optical fiber 10 is sub-divided into first (12), second (14), and third (15) segments of the continuous length l, with second segment 14 interposed between first and third segments 12, 15. This configuration is merely exemplary, however, and it is contemplated that second segment 14 may instead be positioned anywhere along continuous length l.

For instance, there may be no third segment 15, such that optical fiber 10 terminates at the distal end of second segment 14. A delivery fiber may be spliced onto the distal end of second segment 14 to transmit light from optical fiber 10 to a process head. Of course, it is also within the scope of the instant disclosure to include third segment 15 as well as a delivery fiber spliced onto the distal end of third segment 15 (that is, a delivery fiber may be spliced to the distal end of optical fiber 10, no matter how many segments it contains).

As another example, the relative positions of first segment 12 and second segment 14 may be reversed. That is, light may propagate through first and second segments 12, 14 in either order. Thus, the terms “first” and “second” are not intended to connote a particular direction for the propagation of light through optical fiber 10, but rather are used to distinguish a perturbation-sensitive segment from another segment of optical fiber 10. An input fiber may be spliced to either end of optical fiber 10, no matter how many segments it contains.

In FIG. 1, second segment 14 is distinguishable from first and third segments 12, 15 by solid lines drawn perpendicular to the fiber axis. It should be understood, however, that these lines are provided to aid the reader in understanding the instant disclosure and that an actual optical fiber 10 may not include physical indicia to demarcate the position of second segment 14 along the continuous length l. In embodiments of the disclosure, second segment 14 may have a length of between about 1 cm and about 100 cm, though this range is merely illustrative and should not be regarded as limiting.

As discussed in further detail below, first segment 12 has a first refractive index profile (RIP), and second segment 14 has a second RIP different from the first RIP. As those of ordinary skill in the art will appreciate from the discussion below, third segment 15 will often have the same RIP as first segment 12, and will be described as such herein. This is not required, however, and third segment 15 may have a RIP that differs from those of both first segment 12 and second segment 14 without departing from the scope of the present disclosure.

More particularly, the second RIP renders second segment 14 more sensitive to perturbation of optical fiber 10 than first segment 12 (and optional third segment 15). That is, within the context of optical fiber 10, second segment 14 is a perturbation-sensitive segment as defined above.

Several embodiments of optical fibers having perturbation-sensitive segments will be described below. Wherever possible, similar numbering as used in the description of representative optical fiber 10 of FIG. 1 will be adhered to (e.g., reference numeral X0 will be used to refer to the optical fiber; reference numerals X2, X4, and X5 will be used to refer to the first, second, and third segments of the optical fiber; and so on). This numbering convention will assist the ordinarily skilled artisan in applying the teachings above to the several embodiments described herein.

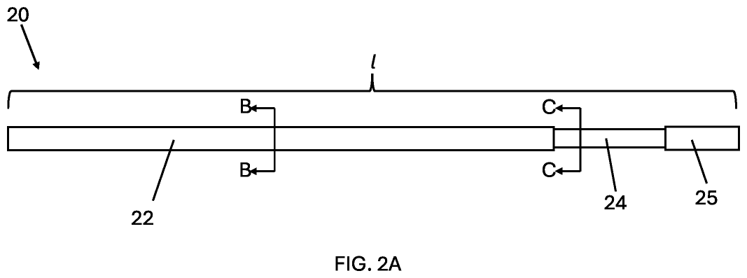

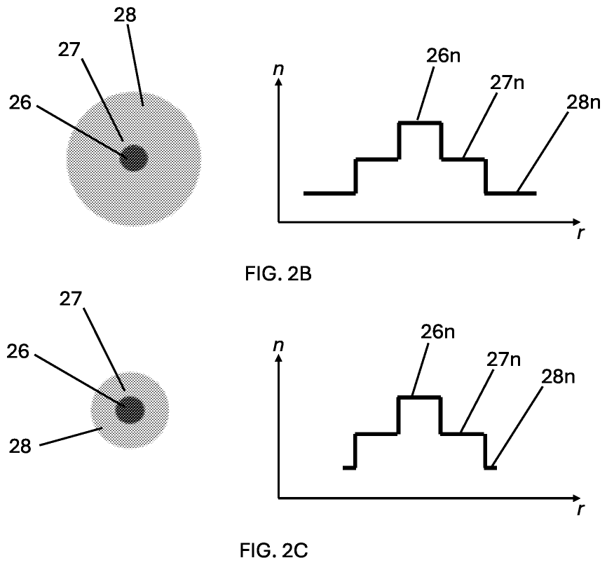

FIG. 2A depicts an optical fiber 20 according to a first embodiment of the instant disclosure. As shown in FIG. 2A, optical fiber 20 includes a first segment 22, a second segment 24, and a third segment 25. Second segment 24 is interposed between first and third segments 22, 25.

FIG. 2B is a transverse cross-sectional view of optical fiber 20 taken along line B-B in FIG. 2A (i.e., within first segment 22) and its corresponding RIP. As shown in FIG. 2A, optical fiber 10 includes a core region 26 having a highest refractive index 26n, a first cladding region 27 having an intermediate refractive index 27n, and a second cladding region 28 having a lowest refractive index 28n. This configuration is commonly known as a “double-clad fiber.”

FIG. 2C is a transverse cross-sectional view of optical fiber 20 taken along line C-C in FIG. 2A (i.e., within second segment 24) and its corresponding RIP. As can be seen in FIG. 2A, as well as by comparing FIG. 2B with FIG. 2C, optical fiber 20 has a transverse cross-sectional dimension (e.g., an outer diameter) that varies along the continuous length/of optical fiber 20. In particular, the outer diameter of optical fiber 20 is greater within first segment 22 and third segment 25 than within second segment 24. It is contemplated that the outer diameter of optical fiber within second segment 24 may be between about 20% and about 90% of the outer diameter of optical fiber within first segment 22 and third segment 25 (that is, the ratio of the outer diameter of first segment 22 or third segment 25 to the outer diameter of second segment 24 may be between about 1.1 and about 5).

The reduced outer diameter of second segment 24 of optical fiber 20 may be formed by removing at least a portion of the thickness of one or more of cladding regions 27, 28 about the circumference of second segment 24. For instance, the desired thickness(es) may be removed via an etching process, a grinding process, an evaporative process, or any other ablation or removal technique familiar to one of ordinary skill in the art.

It should also be understood that, although FIG. 2A depicts relatively sharp transitions between first segment 22 and third segment 25, on the one hand, and second segment 24, on the other hand, smoother transitions are contemplated. For instance, progressively more of the thickness(es) of cladding regions 27, 28 may be removed as one moves along the continuous length/from first segment 22 into second segment 24; conversely, progressively less of the thickness(es) of cladding regions 27, 28 may be removed as one moves along the continuous length/from second segment 24 into third segment 25. This progressive removal may be in a series of discrete steps (e.g., stepwise) or substantially continuous (e.g., smoothly sloped, tapered, or curved).

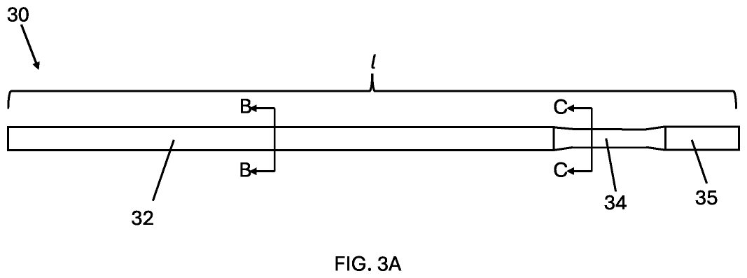

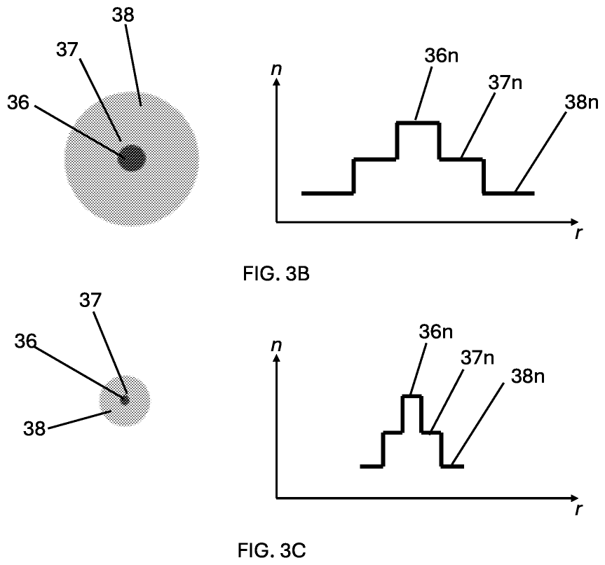

FIG. 3A depicts an optical fiber 30 according to a second embodiment of the instant disclosure. As shown in FIG. 3A, optical fiber 30 includes a first segment 32, a second segment 34, and a third segment 35, with second segment 34 interposed between first and third segments 32, 35.

FIG. 3B is a transverse cross-sectional view of optical fiber 30 taken along line B-B in FIG. 3A (i.e., within first segment 32) and its corresponding RIP. As in FIG. 2A, optical fiber 30 is a double-clad fiber including a core region 36 having a highest refractive index 36n, a first cladding region 37 having an intermediate refractive index 37n, and a second cladding region 38 having a lowest refractive index 38n.

FIG. 3C is a transverse cross-sectional view of optical fiber 30 taken along line C-C in FIG. 3A (i.e., within second segment 34) and its corresponding RIP. As can be seen in FIG. 3A, as well as by comparing FIG. 3B with FIG. 3C, optical fiber 30 has a transverse cross-sectional dimension (e.g., an outer diameter) that varies along the continuous length/of optical fiber 30. In particular, the outer diameter of optical fiber 30 is greater within first segment 32 and third segment 35 than within second segment 34. It is contemplated that the outer diameter of optical fiber within second segment 34 may be between about 20% and about 90% of the outer diameter of optical fiber within first segment 32 and third segment 35 (that is, the ratio of the outer diameter of first segment 32 or third segment 35 to the outer diameter of second segment 34 may be between about 1.1 and about 5).

In contrast to optical fiber 20 of FIGS. 2A-2C, the reduced outer diameter of second segment 34 of optical fiber 30 may be formed by stretching optical fiber 30 within second segment 34. By stretching optical fiber 30 in this manner, the RIP of second segment 34 will be a proportional reduction of the RIP of first segment 32 and third segment 35. In this disclosure, “proportional reduction” means that the differences in the refractive indices of core region 36, first cladding region 37, and second cladding region 38 remain essentially the same (thereby largely preserving the numerical aperture of core region 36 and first cladding region 37), but the radial widths of those regions are proportionally reduced. Stretching produces a tapering between first segment 32 and second segment 34 and between third segment 35 and second segment 34. The length of the taper (or the rate of tapering) may be the same or different on the two sides of second segment 34. There may be an untapered length (e.g., constant diameter) somewhere along second segment 34, or the diameter may be non-constant along the entirety of second segment 34.

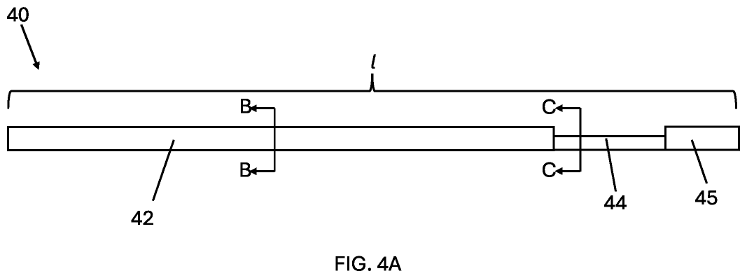

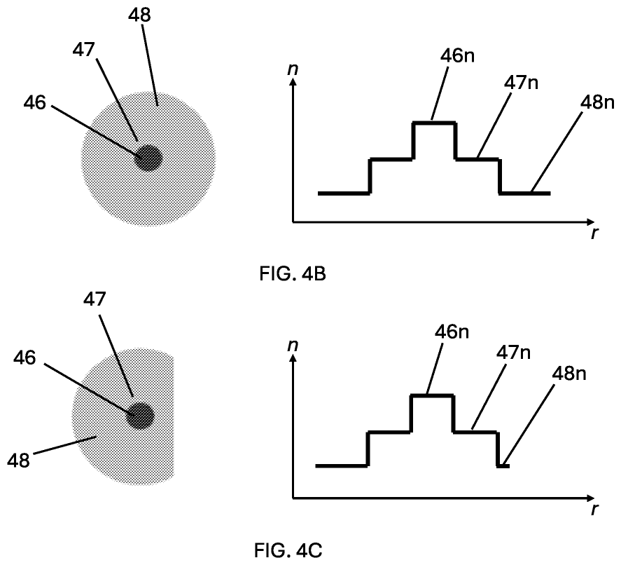

FIG. 4A depicts an optical fiber 40 according to a third embodiment of the instant disclosure. As shown in FIG. 4A, optical fiber 40 includes a first segment 42, a second segment 44, and a third segment 45, with second segment 44 interposed between first and third segments 42, 45.

FIG. 4B is a transverse cross-sectional view of optical fiber 40 taken along line B-B in FIG. 4A (i.e., within first segment 42) and its corresponding RIP. As in FIG. 2A, optical fiber 40 is a double-clad fiber including a core region 46 having a highest refractive index 46n, a first cladding region 47 having an intermediate refractive index 47n, and a second cladding region 48 having a lowest refractive index 48n.

FIG. 4C is a transverse cross-sectional view of optical fiber 40 taken along line C-C in FIG. 4A (i.e., within second segment 44) and its corresponding RIP. As can be seen in FIG. 4A, as well as by comparing FIG. 4B with FIG. 4C, optical fiber 40 has a transverse cross-sectional shape that varies along the continuous length/of optical fiber 40. In particular, the transverse cross-sectional shape of optical fiber 40 is circular within first segment 42 and third segment 45. On the other hand, the transverse cross-sectional shape of optical fiber 40 within second segment 44 is non-circular and does not have cylindrical symmetry.

Other non-circular transverse cross-sectional shapes are also contemplated. For example, the transverse cross-sectional shape of first segment 42 and third segment 45 may be square, hexagonal, or octagonal. Stated more generally (for the non-circular case), the transverse cross-sectional shape of optical fiber 40 within first segment 42 and third segment 45 may have n-fold symmetry, and the transverse cross-sectional shape of optical fiber within second segment 44 may not have n-fold symmetry (n being an integer greater than 1). For instance, second segment 44 may have a D-shaped transverse cross-sectional shape (n=1) that may be formed by removing at least a portion of the thickness(es) of one or more of cladding regions 47, 48 asymmetrically about the circumference of second segment 44 (the shape shown in FIG. 4C is often referred to as “D-shaped”). Non-cylindrically symmetric removal of the desired thickness(es) may be accomplished via an etching process, a grinding process, an evaporative process, or any other ablation or removal technique familiar to one of ordinary skill in the art.

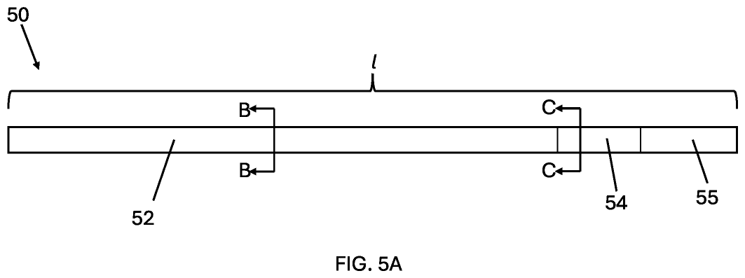

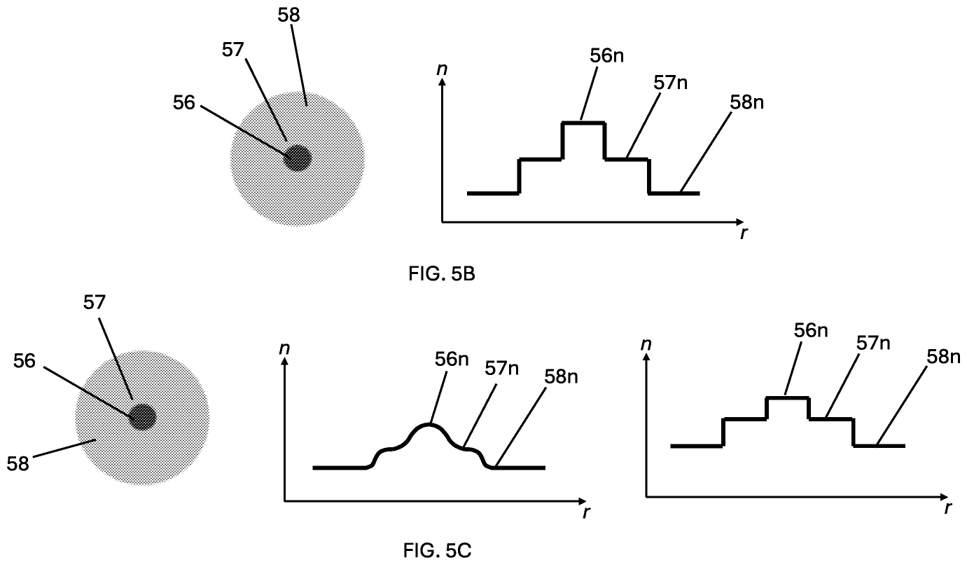

FIG. 5A depicts an optical fiber 50 according to a fourth embodiment of the instant disclosure. As shown in FIG. 5A, optical fiber 50 includes a first segment 52, a second segment 54, and a third segment 55, with second segment 54 interposed between first and third segments 52, 55.

FIG. 5B is a transverse cross-sectional view of optical fiber 50 taken along line B-B in FIG. 5A (i.e., within first segment 52) and its corresponding RIP. As in FIG. 2A, optical fiber 50 is a double-clad fiber including a core region 56 having a highest refractive index 56n, a first cladding region 57 having an intermediate refractive index 57n, and a second cladding region 58 having a lowest refractive index 58n.

FIG. 5C is a transverse cross-sectional view of optical fiber 50 taken along line C-C in FIG. 5A (i.e., within second segment 54) and two possible corresponding RIPs. Unlike optical fibers 20, 30, and 40, discussed above, the transverse-cross sectional shape of optical fiber 50 is consistent along the continuous length l. Second segment 54 is, however, thermally treated (e.g., heated) to cause dopants to diffuse and/or evaporate, thereby changing the RIP. This phenomenon is described, for example, in Xuanfeng Zhou et al., “Mode field adaptation between single-mode fiber and large mode area fiber by thermally expanded core technique,” Optics & Laser Technology 47 (2013), pp.72-75, which is hereby incorporated by reference as though fully set forth herein.

For instance, thermal treatments that cause dopants to diffuse may result in a RIP for second segment 54 that is smoother than the RIPs for first segment 52 and third segment 55. Thermal treatments that cause dopants to diffuse also may result in a RIP for second segment 54 that is both smoother and characterized by lower index differences between some or all of the regions than the RIP for first segment 52 and third segment 55; an exemplary such RIP is shown as the left-hand RIP in FIG. 5C.

Other thermal treatments may cause dopants to evaporate. Depending on the dopant(s) evaporated, the refractive index for one or more doped regions may increase or decrease to be closer to or further from the refractive index of an adjacent region. For instance, in the exemplary right-hand RIP of FIG. 5C, refractive indices 57n and 58n have both increased within second segment 54 relative to their values within first segment 52 and third segment 55 and are thus closer to the (substantially identical) refractive index 56n. Those of ordinary skill in the art will recognize which dopants (e.g., fluorine, boron), when evaporated, will increase the refractive index and which dopants (e.g., germanium), when evaporated, will decrease the refractive index. Note that other fiber modifications (e.g., tapering or stretching discussed above) may also result in dopant diffusion and/or evaporation, so the modifications described herein are not mutually exclusive and can be applied in various combinations.

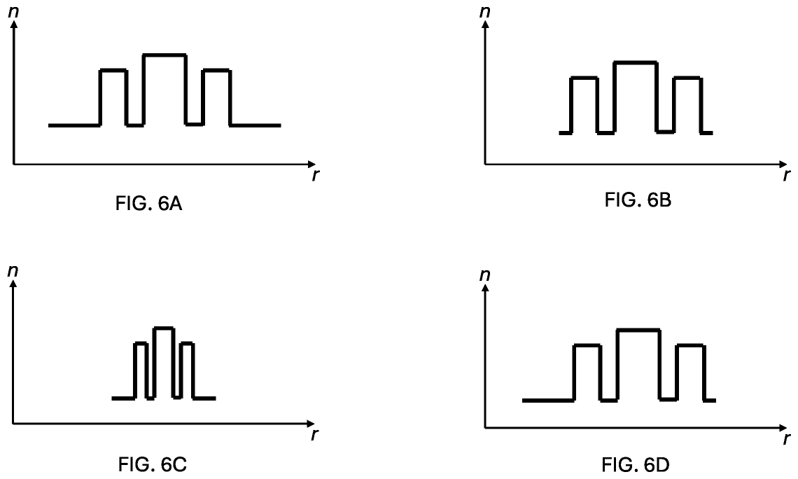

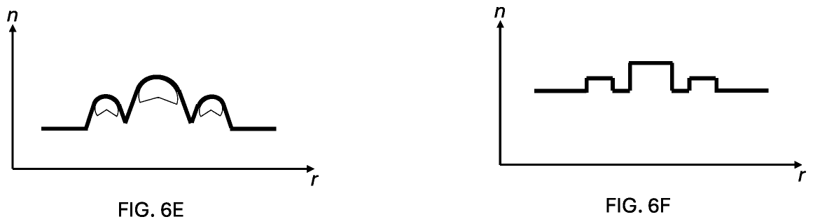

As described above, optical fibers 20, 30, 40, and 50 are double-clad optical fibers. Similar approaches can, however, be applied to other optical fiber designs. To provide additional illustrations, FIGS. 6A, 6B, 6C, 6D, 6E, and 6F are RIPs for core-and-ring optical fiber designs, as follows:
FIG. 6A depicts the RIP within the first segment of a core-and-ring optical fiber according to the teachings herein (e.g., along line B-B in any of FIGS. 2A, 3A, 4A, or 5A);
FIG. 6B depicts the RIP within the second segment of a core-and-ring optical fiber where at least a portion of the thickness of an outer cladding layer has been removed (e.g., by etching, grinding, evaporation, or another ablation or removal technique familiar to one of ordinary skill in the art) symmetrically about the perimeter of the optical fiber (e.g., analogous to line C-C in FIG. 2A);
FIG. 6C depicts the RIP within the second segment of a core-and-ring optical fiber where the second segment has been stretched or tapered to form a second segment with a smaller diameter exhibiting a proportional reduction of the RIP of the first segment (e.g., analogous to line C-C in FIG. 3A);
FIG. 6D depicts the RIP within the second segment of a core-and-ring optical fiber where at least a portion of the thickness of an outer cladding layer has been removed (e.g., by etching, grinding, evaporation, or another ablation or removal technique familiar to one of ordinary skill in the art) asymmetrically about the perimeter of the optical fiber (e.g., analogous to line C-C in FIG. 4A);
FIG. 6E depicts the RIP within the second segment of a core-and-ring optical fiber where the second segment has been thermally treated to smooth and change the numerical aperture of the guiding regions via evaporation and/or diffusion of dopants (e.g., analogous to line C-C in FIG. 5A in the left-hand RIP of FIG. 5C); and
FIG. 6F depicts the RIP within the second segment of a core-and-ring optical fiber where the second segment has been thermally treated to modify the refractive index within one or more cladding regions via evaporation of dopants (e.g., analogous to line C-C in FIG. 5A in the right-hand RIP of FIG. 5C), which changes the numerical aperture of the guiding regions.

The above-described optical fiber embodiments generally create a perturbation-sensitive second segment by making one or more regions of the optical fiber within the second segment less guiding, such as by making them thinner and/or by bringing their respective refractive indices closer together (i.e., decreasing the numerical aperture). Thus, the foregoing modifications to the RIP of the second segment of an optical fiber make it easier to cause light to couple between regions of the optical fiber within the second segment, relative to the first segment, through perturbation of the optical fiber (e.g., macro-bending, micro-bending, or imposition of a transient long-period fiber Bragg grating).

In an additional aspect of the instant disclosure, and referring again to the schematic depiction of optical fiber 10 in FIG. 1, second segment 14 may be rendered perturbation-sensitive by at least partially covering the perimeter of second segment 14 with a material (e.g., a liquid, polymer, semiconductor, or metal/metal alloy). This covering material may change the guiding properties of the fiber and thereby render it more sensitive to perturbations. For example, the covering material may have a different refractive index than the material it has replaced, which can change the numerical aperture of the segment. In addition, the covering material may have a refractive index that can be varied via application of perturbations (e.g., thermal variations, optical illumination, acoustic variations, mechanical stimulus, and so forth). The covering material may also render the fiber more sensitive to perturbations by facilitating application or coupling of mechanical, acoustic, or thermal stress to the fiber.

One or more selected covering materials may be applied as a coating to some or all of the perimeter of second segment 14. Alternatively, second segment 14 may be immersed or submerged in the covering material. These approaches may be particularly desirable where the evanescent field of optical fiber 10 extends radially beyond the outer surface of optical fiber 10 (i.e., beyond the outermost cladding layer).

In use, the perturbation sensitivity achieved via application of the foregoing teachings can be leveraged, for example, to more easily switch light propagating in the core (e.g., 26 in FIG. 2C) into a combination of the core and first cladding region (e.g., 26 and 27 in FIG. 2C) of a double-clad optical fiber. Similarly, this perturbation sensitivity can be leveraged to more easily switch some or all of the light propagating in the central core of a core-and-ring optical fiber into a ring core of such a fiber. In either case, the result is an adjustment to the shape of the beam that is output from the distal end of the optical fiber.

For example, in the late 1990s, researchers at the Naval Research Laboratory and Sandia National Laboratories published a paper describing use of a mechanical perturbation of a fiber (e.g., bending) to couple light from the core to the inner cladding of a double-clad fiber, a phenomenon known as bend loss. Jeffrey P. Koplow, Lew Goldberg, and Dahv A. V. Kliner, “Compact 1-W Yb-Doped Double-Cladding Fiber Amplifier Using V-Groove Side-Pumping,” IEEE Photonics Technology Letters, Vol. 10, No. 6 (June 1998), pp. 793-795. In a later paper, these same researchers described using mode-selective bend loss to modify beam characteristics (specifically, beam quality and beam shape) in a double-clad fiber. Jeffrey P. Koplow, Dahv A. V. Kliner, and Lew Goldberg, “Single-mode Operation of a Coiled Multimode Fiber Amplifier,” Optics Letters, Vol. 25 (Apr. 1, 2000), p. 442.

Against this backdrop, it is easier to induce bend loss and/or mode coupling in a perturbation-sensitive segment of the optical fiber (e.g., second segment 24) than in the remainder of the optical fiber (e.g., first segment 22 and third segment 25). Indeed, as mentioned above, it is contemplated that the same amount of bend loss may be achieved over a considerably shorter distance and/or at a significantly higher bend radius in the perturbation-sensitive segment (e.g., second segment 24) of an optical fiber according to the present teachings than would be possible in the remainder of the optical fiber (e.g., first segment 22 and third segment 25).

For example, in comparing a perturbation-sensitive segment according to the present teachings to the unmodified fiber segment(s), the required length of fiber to achieve a given amount of bend loss can be reduced by a factor of ten or more, and/or the bend radius can be increased by a factor of two or more. Such changes greatly improve the practicality of implementation of the perturbation mechanism (e.g., by allowing perturbation conditions that do not unacceptably degrade the reliability of the fiber and/or that facilitate compact packaging). Note that these values are illustrative and are meant to indicate the significance of the modification, and they should not be regarded as limiting the value or magnitude of the increase in perturbation sensitivity required to fall within the scope of the instant disclosure.

Although several embodiments have been described above with a certain degree of particularity, those skilled in the art could make numerous alterations to the disclosed embodiments without departing from the spirit or scope of this invention.

For example, aspects of the disclosure have been described with reference to double-clad optical fibers and core-and-ring optical fibers, having circular transverse cross-sections and wherein each region of the optical fiber has a constant refractive index. Those of ordinary skill in the art will appreciate, however, that the teachings herein can be extended and adapted to other optical fiber configurations, such as optical fibers with other RIPs (e.g., step-index optical fibers; triple-clad optical fibers; optical fibers in which one or more regions have a graded or otherwise non-constant refractive index), optical fibers with non-coaxial regions, optical fibers with non-circular transverse cross-sections (e.g., optical fibers with a regular n-gonal transverse cross-section), optical fibers with multiple annular guiding regions, microstructured or photonic crystal optical fibers, optical fibers exhibiting gain (i.e., non-passive optical fibers), optical fibers with a variety of dopants, non-silica-based optical fibers, and combinations of the above.

As another example, the teachings herein can be applied in various combinations. For instance, although perturbation-sensitive segments formed by tapering and perturbation-sensitive segments formed by immersing, surrounding, or coating the segment with a material having desired optical properties are disclosed as separate embodiments, it is also contemplated that a perturbation-sensitive segment may be formed by both tapering and immersing, surrounding, or coating the tapered segment with a material having desired optical properties. Of course, this particular combination is merely illustrative, and other permutations and combinations of the aspects disclosed herein that will commend themselves to the attention of an ordinarily skilled artisan are likewise regarded as within the scope of the present disclosure.

As yet another example, although the optical fibers disclosed herein can, standing alone, allow a certain degree of adjustment to beam characteristics, it is also contemplated that the optical fibers disclosed herein can be employed to good advantage as the first length of fiber in, for example, U.S. Pat. Nos. 10,295,845; 10,423,015; and 10,663,767, discussed above, as well as various applications claiming priority thereto.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An optical fiber having a continuous length, the optical fiber comprising:
a first segment of the continuous length, having a first refractive index profile (RIP); and
a second segment of the continuous length, having a second RIP different from the first RIP,
wherein the second RIP renders the second segment more sensitive to perturbation of the optical fiber than the first segment.

2. The optical fiber according to claim 1, wherein a length of the second segment is between 1 cm and 100 cm.

3. The optical fiber according to claim 1, wherein the optical fiber has a transverse cross-sectional dimension that varies along the continuous length, and wherein the transverse cross-sectional dimension of the optical fiber within the first segment is greater than the transverse cross-sectional dimension of the optical fiber within the second segment.

4. The optical fiber according to claim 3, wherein the transverse cross-sectional dimension within the second segment is between 20% and 90% of the transverse cross-sectional dimension within the first segment.

5. The optical fiber according to claim 4, wherein:
the optical fiber has a transverse cross-sectional shape that varies along the continuous length,
the transverse cross-sectional shape within the first segment has n-fold symmetry about an axis along the continuous length,
the transverse cross-sectional shape within the second segment does not have n-fold symmetry about the axis along the continuous length, and
n is an integer greater than one.

6. The optical fiber according to claim 3, wherein:
the transverse cross-sectional shape within the first segment is circular, and
the transverse cross-sectional shape within the second segment is non-circular.

7. The optical fiber according to claim 3, wherein the transverse cross-sectional shape within the second segment is D-shaped.

8. The optical fiber according to claim 3, wherein the transverse cross-sectional dimension is an outer diameter, and wherein a ratio of the outer diameter of the optical fiber within the first segment to the outer diameter of the optical fiber within the second segment is between 1.1 and 5.

9. The optical fiber according to claim 8, wherein the outer diameter of the optical fiber within the first segment tapers to the outer diameter of the optical fiber within the second segment at a transition between the first segment and the second segment.

10. The optical fiber according to claim 9, wherein the second RIP is a proportional reduction of the first RIP.

11. The optical fiber according to claim 8, wherein the optical fiber comprises an outer cladding extending along the continuous length, and wherein at least a portion of a thickness of the outer cladding is removed about a circumference of the second segment.

12. The optical fiber according to claim 1, wherein the optical fiber comprises an outer cladding extending along the continuous length, wherein the outer cladding has a refractive index, and wherein the refractive index of the outer cladding is higher within the second segment than within the first segment.

13. The optical fiber according to claim 1, further comprising a third segment of the continuous length, having a third RIP, and wherein the second segment of the continuous length is interposed between the first segment and the third segment.

14. The optical fiber according to claim 13, wherein the third RIP is identical to the first RIP.

15. A method of manufacturing an optical fiber having a continuous length, the method comprising:
forming a first segment of the continuous length, the first segment having a first refractive index profile (RIP); and
forming a second segment of the continuous length, the second segment having a second RIP different from the first RIP,
wherein the second RIP renders the second segment more sensitive to perturbation of the optical fiber than the first segment.

16. The method according to claim 15, wherein:
the optical fiber has a transverse cross-sectional dimension, and
forming the second segment of the continuous length comprises reducing the transverse cross-sectional dimension of the optical fiber within the second segment.

17. The method according to claim 16, wherein reducing the transverse cross-sectional dimension of the optical fiber within the second segment comprises stretching the second segment such that the second RIP is a proportional reduction of the first RIP.

18. The method according to claim 16, wherein reducing the transverse cross-sectional dimension of the optical fiber within the second segment comprises removing at least a portion of a thickness of an outer cladding of the optical fiber within the second segment.

19. The method according to claim 18, wherein removing at least the portion of the thickness of the outer cladding of the optical fiber within the second segment comprises removing at least the portion of the thickness of the outer cladding of the optical fiber such that a transverse cross-sectional shape of the second segment does not have n-fold symmetry, where n is an integer greater than one, about an axis along the continuous length.

20. The method according to claim 18, wherein removing at least the portion of the thickness of the outer cladding of the optical fiber within the second segment comprises at least one of grinding away at least the portion of the thickness of the outer cladding of the optical fiber, etching away at least the portion of the thickness of the outer cladding of the optical fiber, and evaporating away at least the portion of the thickness of the outer cladding of the optical fiber.

21. The method according to claim 15, wherein forming the second segment of the continuous length comprises heating the second segment of the continuous length.
